(19) United States
(12) Patent Application Publication
(10) Pub. No.: US 2013/0275183 A1
(43) Pub. Date: Oct. 17, 2013

(54) TIME-DEPENDENT PRODUCT PRICING OPTIMIZER

(71) Applicants: Maxime COHEN, Cambridge, MA (US); Andrew VAKHUTINSKY, Norwood, MA (US); Kiran PANCHAMGAM, Woburn, MA (US)

(72) Inventors: Maxime COHEN, Cambridge, MA (US); Andrew VAKHUTINSKY, Norwood, MA (US); Kiran PANCHAMGAM, Woburn, MA (US)

(73) Assignee: ORACLE INTERNATIONAL CORPORATION, Redwood Shores, CA (US)

(21) Appl. No.: 13/481,140

(22) Filed: May 25, 2012

Related U.S. Application Data
(60) Provisional application No. 61/622,780, filed on Apr. 11, 2012.

(51) Int. Cl. G06Q 30/02

(52) U.S. Cl. 705/7.35

(57) ABSTRACT

A system for determining time-dependent product pricing for a product category receives a non-linear problem for the product category, in which the non-linear problem includes a demand model. For a plurality of pair of products in the product category, the system determines coefficients for a change in demand of a first product at each of a plurality of time periods when a price of a second product is changed. The system then generates an approximate Mixed Integer Linear Programming (“MILP”) problem that includes a change of demand based on a sum of the determined coefficients. The system then solves the MILP problem to obtain a MILP solution, which provides the product pricing.

### CROSS REFERENCE TO RELATED APPLICATIONS

This application claims priority of U.S. Provisional Application Ser. No. 61/622,780, filed on Apr. 11, 2012, the contents of which is hereby incorporated by reference.

### FIELD

One embodiment is directed generally to a computer system, and in particular to a computer system that optimizes product pricing.

### BACKGROUND INFORMATION

Product line pricing is an important business problem faced by retailers and other sellers of merchandise who employ dynamic pricing strategies to generate incremental revenue benefits throughout the year. Retailers, among others, have in increasing numbers begun to utilize decision support systems that leverage the large volume of detailed demand data to automate and optimize pricing recommendations. In particular, the statistical modeling of the price elasticity of items based on analyzing the effect of price changes of one product on its demand, or the demand for another product, can be used to optimize the pricing of products.

Known price optimizers, in general, are given a set of items in a product category together with their current prices and demand cross-elasticity. The optimizers then find a new set of prices that would satisfy all business rules and maximize the profit margin by taking into account some soft price constraints and allowed prices.

### SUMMARY

One embodiment is a system for determining time-dependent product pricing for a product category. The system receives a non-linear problem for the product category, in which the non-linear problem includes a demand model. For a plurality of pair of products in the product category, the system determines coefficients for a change in demand of a first product at each of a plurality of time periods when a price of a second product is changed. The system then generates an approximate Mixed Integer Linear Programming (“MILP”) problem that includes a change of demand based on a sum of the determined coefficients. The system then solves the MILP problem to obtain a MILP solution, which provides the product pricing.

### BRIEF DESCRIPTION OF THE DRAWINGS

FIG. 1 is a block diagram of a computer system that can implement an embodiment of the present invention.

FIG. 2 is a flow diagram of the functionality of a product pricing module of FIG. 1 when generating time-dependent optimized product pricing in accordance with one embodiment.

FIGS. 3a and 3b are graphs that illustrates a comparison of the approximation of embodiments of the present invention with the Taylor approximation.

### DETAILED DESCRIPTION

One embodiment is a price optimizer that optimizes prices for product items in a given merchandise category to maximize the total revenue subject to linear constraints and dependent on the specific time period during a selling season. The optimizer determines, for a pair of products at each time period, a set of coefficients that express the changes in demand when the price of one product is changed. Using the coefficients, an approximate linear Mixed Integer Linear Programming (“MILP”) problem is formulated in place of the original, non-linear demand problem, which can then be solved to determine the optimized prices.

In general, one embodiment is a price optimizer that calculates a time-dependent set of recommended prices or validates a set of user-defined input prices, given the following inputs:
a. Sales and cost data for a given demand group and location;
b. Current prices and competitor prices per demand group;
c. Pricing and competition constraints per demand group;
d. Goals for sales, revenue, gross-margin, and competitive price index (CPI) per demand group;
e. Weighted objective function that is a linear combination of the sales, revenue, gross-margin, and CPI per demand group;
f. Choice of the demand forecast model;
g. Certain demand model parameters for the chosen forecast model; and
h. Time periods during a selling season.

Many real-world optimization problems are formulated to minimize or maximize a nonlinear time-dependent function of discrete variables subject to certain constraints involving that function or some linear functions of its arguments. An example of this problem type is the maximization of some objective function (e.g., the total profits or total revenues) for several merchandise items in a product category where demand for each item is expressed as a nonlinear function of all item prices, which can take values only from specific price ladders (i.e., a set of allowed prices), with the pricing dependent on time periods during the selling season. For example, men's suits may have four distinct selling seasons: Winter, Spring, Summer and Fall, or Graduation season, Wedding season, etc. Seasonality can play large role in some grocery products. For example, pumpkin-related items can have a regular and holiday season, cold beverages can see spike in sales in summer months compared to winter months, etc.

In general, and in accordance with embodiments of the present invention, a time-dependent price optimization problem can be stated as follows: Find the best prices (p₁^{t}, . . . , pₙ^{t}) for the n product items at each time-period “t” over the selling season in a given merchandise category to maximize the total profits subject to certain linear constraints when demand for the i^{th} item at time t is expressed as a given function sᵢ^{t}=fᵢ^{t}(p₁^{t}, . . . , pₙ^{t}) (e.g., “demand model”).

The problem (the “time-dependent price optimization problem”, or equations (1-12)) can also be expressed as follows:

$$\begin{matrix}{max}_{{p}_{i}^{t} , {b}_{i}^{t}} Obj ( {p}_{i}^{t} ) & & ( maximize some objective func . ) \\ s . t . & {s}_{i}^{t} = {f}_{i}^{t} ( {p}_{1}^{t} , {p}_{2}^{t} , … , {p}_{n}^{t} ) & ( sales as function of prices ) \\ & {p}_{i}^{t} - {p}_{i}^{t - 1} \leq {b}_{i}^{t} \cdot Δ ; ∀ i = 1 , 2 , … , n and ∀ t = 1 , 2 , … , T & ( price diff . forcing constraint ) \\ & {p}_{i}^{t - 1} - {p}_{i}^{t} \leq {b}_{i}^{t} \cdot Δ ; ∀ i = 1 , 2 , … , n and ∀ t = 1 , 2 , … , T & ( price diff . forcing constraint ) \\ & {\sum }_{k = t}^{min ( t + {τ}_{i} - 1 , T )} {b}_{i}^{k} \leq 1 ; ∀ i = 1 , 2 , … , n and ∀ t = 1 , 2 , … , T & ( ‘ no touch ’ period ) \\ & {\sum }_{t = 1}^{T} {b}_{i}^{t} \leq {K}_{i} ; ∀ t = 1 , 2 , … , n & ( max . price change per item ) \\ & {\sum }_{i = 1}^{n} {b}_{i}^{t} \leq {N}_{t} ; ∀ t = 1 , 2 , … , T & ( max . price change per time ) \\ & {b}_{i}^{t} ∈ \{ 0 , 1 \} ; ∀ i = 1 , 2 , … , n and ∀ t = 1 , 2 , … , T & ( indicator for price change ) \\ & {p}_{i}^{t} ∈ {P}_{i} & ( price ladder ) \\ & ( {p}_{1}^{t} , {p}_{2}^{t} , … , {p}_{n}^{t} ) ∈ {L}_{p} ; ∀ t = 1 , 2 , … , T & ( feasible price constraints ) \\ & ( {s}_{1}^{t} , {s}_{2}^{t} , … , {s}_{n}^{t} ) ∈ {L}_{s} ; ∀ t = 1 , 2 , … , T & ( feasible sales constraints ) \\ & ( {p}_{1}^{t} {s}_{1}^{t} , {p}_{2}^{t} {s}_{2}^{t} , … , {p}_{n}^{t} {s}_{n}^{t} ) ∈ {L}_{r} ; ∀ t = 1 , 2 , … , T & ( feasible revenue constraints )\end{matrix}$$

where:
fᵢ^{t}(p₁^{t}, . . . , pₙ^{t}) is a nonlinear time-dependent expression for the i^{th} item demand at time t as a function of all prices in the category at that time period;
Pᵢ is the price ladder (discrete set) for the i^{th} item;
Δ is the maximal magnitude of price variations allowed for a single change between two successive prices;
τᵢ is the duration of the new price value for the i^{th} item;
Kᵢ and Nₜ represent the imposed limitations on the number of price changes per item and per time-period, respectively;
pᵢ^{t} and bᵢ^{t} are decision variables; bᵢ^{t} are binary variables that indicate if the price of the i^{th} item at time t is varied; and
Lₚ (Lₛ, Lᵣ) are the feasible price (demand and revenue, respectively) regions defined by the linear inter-item constraints and some other business requirements.

This class of problems is known to be difficult to solve to optimality and even finding a high-quality approximate solution is generally intractable. Since the demand function is typically not assumed to be convex or concave, these problems also are not typically solvable by gradient methods even if the price ladder constraint is relaxed and price variables are considered continuous.

Two known examples of modeling product demand as a function of product prices include the “SCAN*PRO” demand model, disclosed for example in K. Talluri and G. Van Ryzin, “The Theory and Practice of Revenue Management”, Chapter 5, Springer 2005, and the multinomial logit (“MNL”) choice-based demand model disclosed in S. Subramanian and H. Sherali, “A fractional programming approach for retail category price optimization”, Journal of Global Optimization (2010) 48:263-277 (“Subramanian”).

In the SCAN*PRO demand model, the demand for the i^{th} item is expressed as

$${d}_{i} ( {p}_{1} , … , {p}_{n} ) = {d}_{i}^{0} {\prod }_{j = 1}^{n} {( \frac{{p}_{j}}{{p}_{j}^{0}} )}^{{Y}_{ij}}$$

where dᵢ⁰ is demand at initial prices (p₁⁰, . . . , pₙ⁰).

In the MNL choice-based demand model, the demand is expressed as

$${d}_{i} ( {p}_{1} , … , {p}_{n} ) = \frac{{e}^{{U}_{i} ( {p}_{i} )}}{{\sum }_{j = 1}^{n} {e}^{{U}_{j} ( {p}_{j} )}} θ ( {p}_{1} , … , {p}_{n} )$$

where Uᵢ(pᵢ) is a utility function based on price pᵢ of the i^{th} item and θ(p₁, . . . , pₙ) is the calibration parameter based on all product prices.

In known product pricing optimizers that generate optimized prices, the optimization problem is typically solved by a series of greedy searches, which sometimes delivers a solution far from optimal. Other known approaches are based on linear or quadratic approximations of the nonlinear demand function. However, these approaches tend to suffer from insufficient accuracy (linear approximation) or an overwhelming number of integer variables needed to formulate the problem.

In Subramanian, the disclosed algorithm is designed to solve the optimization problem for the MNL-based demand model by relying on transformed variables and a piecewise linear approximation. However, this approach depends on the properties of the specific functional form for demand (i.e., the MNL). The solution to the price optimization problem becomes even more challenging when a time dimension is included.

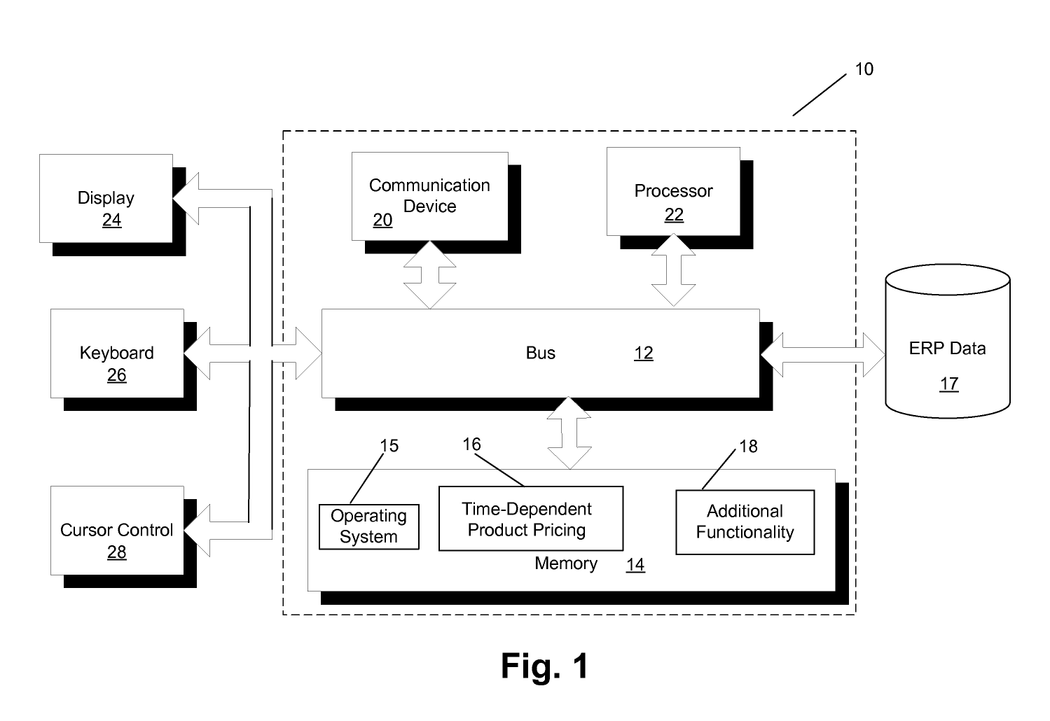

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a time-dependent product pricing module 16 that generates optimized time-dependent product pricing, as disclosed in more detail below. System 10 can be part of a larger system, such as an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing information, inventory information, ERP data, etc.

One embodiment generates optimized prices for each item in the category over the time horizon T (the selling season) by taking advantage of the discrete nature of the variables. However, embodiments can be applicable for a general class of problems, and are not limited to pricing problems.

In one embodiment, a revenue maximization problem is developed and solved for category pricing in the retail industry. However, in other embodiments this problem can be used for any type of product pricing.

For a retail-oriented embodiment, consider a retailer who has to set the baseline (or regular) price levels for some or all active items in a given category for the next few months, as part of a merchandise planning process. The category manager has to make multiple, coordinated pricing decisions, proactively taking into account the impact of a price change on the sales of other items within the category, as well as any (extraneous) market response. Moreover, the recommended prices have to satisfy several category-level objectives such as profitability, sales, and revenue (e.g., to maximize gross margin while ensuring that the total sales and revenue are within 10% of the current value), and have to be selected from within a limited discrete price ladder (e.g., be within 20% of the current price and end with ‘9’ cents). In addition, items have to be priced relative to certain attributes such as brand type (e.g., a store brand tomato soup should be at least a dollar less than the price of the corresponding national brand), and quantity (e.g., a six-pack of diet-soda versus a two-liter bottle of diet-soda), among others. A retailer also has to consider time-varying aspects of items' prices due to seasonality in customer demand, procurement cost fluctuations (e.g., jump in fuel prices, change of suppliers), competitor price changes, etc.

Items can represent stock-keeping units (“SKU”s), product subclasses, or product classes within the category, depending on the level of aggregation in the merchandise hierarchy at which the analysis is performed by the category manager. For simplicity, it is assumed that prices of SKUs are optimized at the store-level of the location hierarchy. However, in other embodiments, the problem can be readily extended to manage higher levels of aggregation (e.g., at the zonal level). Further, the problem can address more general situations faced by category managers such as the need to jointly optimize multiple categories that are inter-linked by pricing constraints and/or objectives, or manage several distinct subsets of substitutable items within the same category.

In one embodiment, it is assumed that inventory is always available, so that the demand are equal to sales. It is further assumed that the sales in a given week depend only on the prices of that week, which can be based on any time-dependent function. In one embodiment, the potentially infeasible demand model, (p₁⁰, . . . , pₙ⁰), is used and the embodiments find a new price vector at each time period over the time horizon in the vicinity of the initial solution in order to generate optimal pricing. However, in other embodiments different demand models can be used.

In one embodiment, sᵢ⁰(t) is denoted as the current demand value at time t where the initial prices are set (i.e., sᵢ⁰(t)≡fᵢ^{t}(p₁⁰, . . . , pₙ⁰). The following set of coefficients are then generated to express the difference between demand value when only one price is changed and the current demand at time t.

δᵢⱼ^{m}(t)=fᵢ^{t}(p₁⁰, . . . , pⱼ₋₁⁰, pⱼ^{m}, pⱼ₊₁⁰, . . . , pₙ⁰)−sᵢ⁰(t).

Embodiments further generate binary decision variables xᵢ^{m}(t) that indicate whether the i^{th} price variable at time t was assigned to the m^{th} price in its ladder:

$${x}_{i}^{m} ( t ) = \{ \begin{matrix}1 & if {p}_{1}^{t} = {p}_{i}^{m} , \\ 0 & otherwise .\end{matrix}$$

A similar set of continuous auxiliary variables yᵢ^{m}(t) are also generated.

Embodiments then generate the following Mixed Integer Linear Programming (“MILP”) problem (“MILP problem” or equations (13-28)):

$${max}_{{x}_{i}^{m} ( t ) , {y}_{i}^{m} ( t ) , {b}_{i}^{t}} {\sum }_{t = 1}^{T} {\sum }_{i = 1}^{n} {\sum }_{m = 1}^{{M}_{i}} ( {p}_{i}^{m} - {c}_{i}^{t} ) {y}_{i}^{m} ( t )$$

$$s . t . \\ {\sum }_{m = 1}^{{M}_{i}} {x}_{i}^{m} ( t ) = 1 ; ∀ i = 1 , 2 , … , n and ∀ t = 1 , 2 , … , T$$

$${\sum }_{m = 1}^{{M}_{i}} {p}_{i}^{m} {x}_{i}^{m} ( t ) - {\sum }_{m = 1}^{{M}_{i}} {p}_{i}^{m} {x}_{i}^{m} ( t - 1 ) \leq {b}_{i}^{t} \cdot M ; ∀ i = 1 , 2 , … , n and ∀ t = 1 , 2 , … , T$$

$${\sum }_{m = 1}^{{M}_{i}} {p}_{i}^{m} {x}_{i}^{m} ( t - 1 ) - {\sum }_{m = 1}^{{M}_{i}} {p}_{i}^{m} {x}_{i}^{m} ( t ) \leq {b}_{i}^{t} \cdot M ; ∀ i = 1 , 2 , … , n and ∀ t = 1 , 2 , … , T$$

$${\sum }_{k = t}^{min ( t + {τ}_{i} - 1 , T )} {b}_{i}^{k} \leq 1 ; ∀ i = 1 , 2 , … , n and ∀ t = 1 , 2 , … , T$$

$${\sum }_{t = 1}^{T} {b}_{i}^{t} \leq {K}_{i} ; ∀ t = 1 , 2 , … , n$$

$${\sum }_{t = 1}^{n} {b}_{i}^{t} \leq {N}_{t} ; ∀ t = 1 , 2 , … , T$$

$${\sum }_{m = 1}^{{M}_{i}} {y}_{i}^{m} ( t ) = {s}_{i}^{0} ( t ) + {\sum }_{j = 1}^{n} {\sum }_{m = 1}^{{M}_{j}} {δ}_{ij}^{m} ( t ) {x}_{j}^{m} ( t ) ; ∀ i and ∀ t$$

$$0 \leq {y}_{i}^{m} ( t ) \leq {s}_{i}^{max} {x}_{i}^{m} ( t )$$

$${b}_{i}^{t} ∈ \{ 0 , 1 \} ; ∀ i = 1 , 2 , … , n and ∀ t = 1 , 2 , … , T$$

$${x}_{i}^{m} ∈ \{ 0 , 1 \} ; ∀ i = 1 , 2 , … , n ∀ m = 1 , 2 , … , {M}_{i} and ∀ t = 1 , 2 , … , T \\ ( {\sum }_{m = 1}^{{M}_{1}} {p}_{1}^{m} {x}_{1}^{m} ( t ) , … , {\sum }_{m = 1}^{{M}_{n}} {p}_{n}^{t} {x}_{n}^{m} ( t ) ) ∈ {L}_{p} ; ∀ t = 1 , 2 , … , T \\ ( {\sum }_{m = 1}^{{M}_{1}} {y}_{1}^{m} ( t ) , … , {\sum }_{m = 1}^{{M}_{n}} {y}_{n}^{m} ( t ) ) ∈ {L}_{s} ; ∀ t = 1 , 2 , … , T \\ ( {\sum }_{m = 1}^{{M}_{1}} {p}_{1}^{m} {x}_{1}^{m} ( t ) , … , {\sum }_{m = 1}^{{M}_{n}} {p}_{n}^{t} {x}_{n}^{m} ( t ) ) ∈ {L}_{r} ; ∀ t = 1 , 2 , … , T$$

The solution to the above MILP problem serves as an approximation to the exact solution of the original time-dependent price optimization problem disclosed above, and can therefore be used to generate optimized prices. Specifically, exactly one xᵢ^{m}(t) variable is guaranteed to be equal to one for each item i at each time t, which also implies that only one yᵢ^{m}(t) variable is non-zero. Further, the non-zero yᵢ^{m}(t) variable is equal to the demand approximation. Finally, the constraints on feasible price (demand and revenue, respectively) regions are similar the constraints in the original time-dependent price optimization problem disclosed above.

The above MILP problem can be solved by any widely available and known MILP solver within the time frame acceptable for most practical applications.

In one embodiment, instead of a general objective function, the total profit margin is maximized without a discount factor. In another embodiment, profits can be restricted to be within a certain numerical limitation (e.g., to increase by 5%) or to achieve some relative or absolute target while minimizing the changes. Further, in one embodiment, a constraint on the deviations of the (weighted) average price at each time can be used in order to prevent approaching the boundaries and to avoid having excessively large variations, which can impact a customer's perception of a retail store.

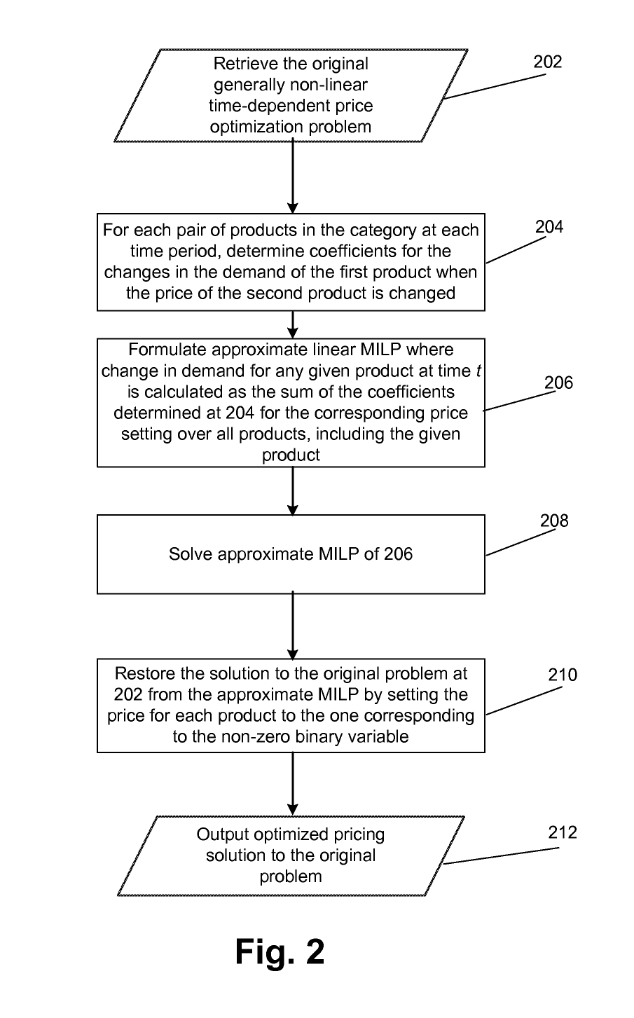

FIG. 2 is a flow diagram of the functionality of time-dependent product pricing module 16 of FIG. 1 when generating time-dependent optimized product pricing in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, the original, generally non-linear time-dependent price optimization problem is read from the input stream or retrieved from memory. In one embodiment, the time-dependent price optimization problem is the problem of equations (1-12) above, and includes a demand model. However, other problems/demand models can be used. In one embodiment, the revenue is maximized for several merchandise items in a category, where demand for each item is expressed as a nonlinear function of all item prices, which can take values only from specific price ladders (i.e., a set of allowed prices) with the pricing dependent on timing periods during the selling season. Input parameters can include various complex time-dependent aspects such as maximum number of price changes per period per item and per item constant price period requirements.

At 204, for each pair of products in the category at each time period, coefficients are determined for the changes in the demand of the first product when the price of the second product is changed from the base (usually initial) level to various other levels in the price ladder of the second product. The coefficients reflect the change of the demand for i^{th} item at time t when j^{th} item price at time t is changed to the m^{th} position in the price ladder. In general, these coefficients are computed for all n² pairs of n products in the category. However, in most practical cases, the product pairs with mutual non-zero price-demand effects are limited to related products. For example, different packaging of the same product or organic and ordinary versions of a grocery item with the same brand and flavor. These coefficients will be usually relatively large when dependency of a particular product demand on its own price is considered (i.e., when the first and the second products in the pair are the same). In contrast, when the products are different, the corresponding demand changing coefficients are relatively small reflecting relatively weak cross product effect.

In one embodiment, the coefficients, which express the difference between demand value when only one price is changed and the current demand at time t is expressed as follows:

δᵢⱼ^{m}(t)=fᵢ^{t}(p₁⁰, . . . , pⱼ₋₁⁰, pⱼ^{m}, pⱼ₊₁⁰, . . . , pₙ⁰)−sᵢ⁰(t).

Embodiments further generate binary decision variables xᵢ^{m}(t) that indicate whether the i^{th} price variable at time t was assigned to the m^{th} price in its ladder:

$${x}_{i}^{m} ( t ) = \{ \begin{matrix}1 & if {p}_{1}^{t} = {p}_{i}^{m} , \\ 0 & otherwise .\end{matrix}$$

A similar set of continuous auxiliary variables yᵢ^{m}(t) are also generated.

At 206, an approximate MILP is formulated where change in demand for any given product at time t is calculated as the sum of the coefficients determined at 204 for the corresponding price setting over all products, including the given product. All other constraints of the original problem are linear by definition and do not need to be changed. The approximate MILP is formulated with time-related constraints sets such as price limitation changes per period and per item, no-touch period requirement and limited average variations.

At 208, the approximate MILP of 206 is solved using any known MILP solver.

At 210, the solution to the original problem at 202 is restored from the approximate MILP by setting the price for each product to the one corresponding to the non-zero binary variable. The constraints of the approximate MILP guarantee that, for each product, only one binary variable indicating the optimal price in the price ladder is set to one while the others are set to zero. In one embodiment, the solution to the MILP problem can be converted to the optimized product prices as follows:

$$for all i = 1 , … , n and t = 1 , … , T : {p}_{i} ( t ) = {\sum }_{m = 1}^{{M}_{i}} {p}_{i}^{m} {x}_{i}^{m} ( t ) .$$

At 212, the optimized pricing solution to the original problem is written to the output stream for reporting and other interface purposes and for determining optimized prices.

The effectiveness of embodiments of the invention can be shown by comparing embodiments with a standard linear approximation approach based on the known first-degree Taylor expansion disclosed in, for example, M. Greenberg, “Advanced Engineering Mathematics (2nd ed.)”, Prentice Hall (1998). Using the Taylor expansion, the δᵢⱼ^{m} coefficients disclosed above become:

$${δ}_{ij}^{m} = \frac{\partial {d}_{i} ( {p}_{1}^{0} , … , {p}_{n}^{0} )}{\partial {p}_{j}} ( {p}_{j}^{m} - {p}_{j}^{0} ) .$$

The difference in the approximations can be shown by comparing the traditional approximation by linearization to the embodiments of the invention for a demand model of:
d₁(p₁, p₂, p₃)=p₁⁻¹p₂^{0.1}p₃^{0.1}, which is the special case of the SCAN*PRO demand model disclosed above.

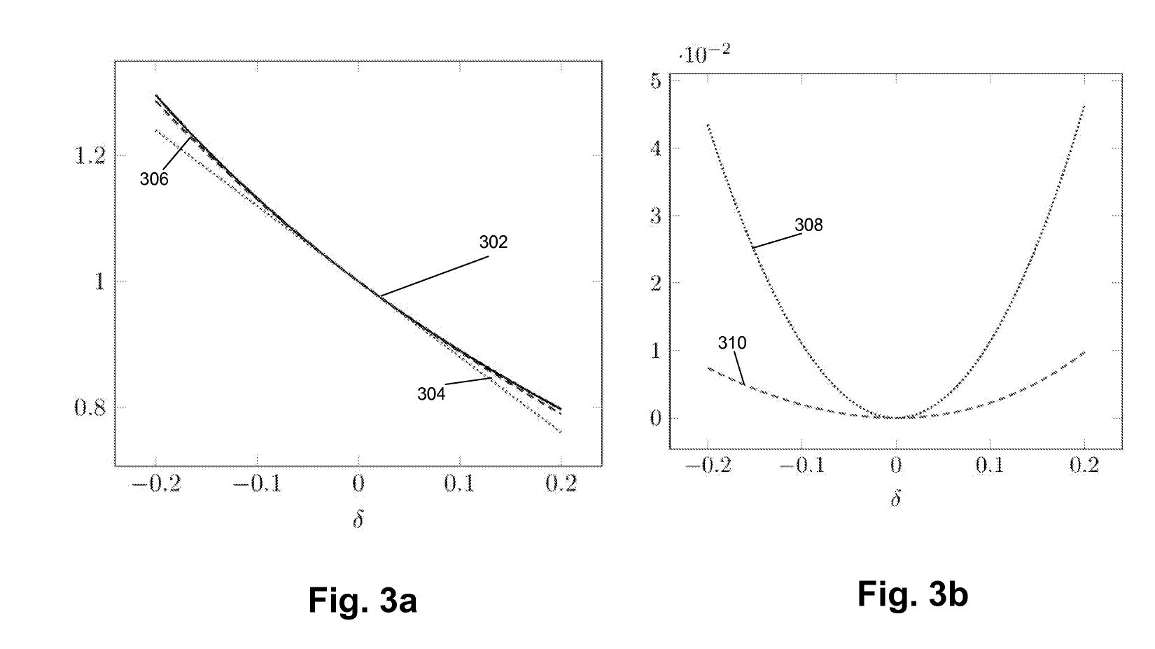

The demand is approximated along the line (1+δ, 1−δ, 1−δ) for δ ε [−0.2,0.2]. FIGS. 3a and 3b are graphs that illustrates a comparison of the approximation of embodiments of the present invention with the Taylor approximation. In FIG. 3a, solid line 302 is the true demand, dotted line 304 is the Taylor approximation, and dashed line 306 is the approximation in accordance with embodiments of the invention. In FIG. 3b, dotted line 308 is the Taylor approximation error, and dotted line 310 is the error in accordance with embodiments of the invention. As shown, the approximation in accordance with embodiments of the present invention is significantly more accurate than the approximation based on the linearization using the Taylor approximation.

As disclosed, embodiments provide time-dependent optimized pricing for a pair of products at each time period by determining coefficients that express a change of demand of one product when the price of the other product has changed. A MILP problem is then formulated using the coefficients, and then solved. As a result, an optimal or near optimal solution to the demand/pricing problem can be determined relatively quickly.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, causes the processor to determine time-dependent product pricing for a product category, the instructions comprising:
receiving a non-linear time-dependent problem for the product category, wherein the non-linear problem comprises a demand model;
for a plurality of pair of products in the product category, determining coefficients for a change in demand of a first product at each of a plurality of time periods when a price of a second product is changed;
generating an approximate Mixed Integer Linear Programming (MILP) problem comprising a change of demand based on a sum of the determined coefficients; and
solving the MILP problem to obtain a MILP solution, wherein the MILP solution provides the product pricing.

2. The computer readable medium of claim 1, wherein the solving the MILP problem comprises setting a solved price of each product to a non-zero binary variable.

3. The computer readable medium of claim 1, wherein the non-linear problem comprises assigning prices on products from a price ladder.

4. The computer readable medium of claim 1, wherein the product category comprises pricing that is at least in part dependent on seasonality.

5. The computer readable medium of claim 1, wherein the non-linear time-dependent problem comprises:
$$\begin{matrix}{max}_{{p}_{i}^{t} , {b}_{i}^{t}} Obj ( {p}_{i}^{t} ) & & ( maximize some objective func . ) \\ s . t . & {s}_{i}^{t} = {f}_{i}^{t} ( {p}_{1}^{t} , {p}_{2}^{t} , … , {p}_{n}^{t} ) & ( sales as function of prices ) \\ & {p}_{i}^{t} - {p}_{i}^{t - 1} \leq {b}_{i}^{t} \cdot Δ ; ∀ i = 1 , 2 , … , n and ∀ t = 1 , 2 , … , T & ( price diff . forcing constraint ) \\ & {p}_{i}^{t - 1} - {p}_{i}^{t} \leq {b}_{i}^{t} \cdot Δ ; ∀ i = 1 , 2 , … , n and ∀ t = 1 , 2 , … , T & ( price diff . forcing constraint ) \\ & {\sum }_{k = t}^{min ( t + {τ}_{i} - 1 , T )} {b}_{i}^{k} \leq 1 ; ∀ i = 1 , 2 , … , n and ∀ t = 1 , 2 , … , T & ( ‘ no touch ’ period ) \\ & {\sum }_{t = 1}^{T} {b}_{i}^{t} \leq {K}_{i} ; ∀ t = 1 , 2 , … , n & ( max . price change per item ) \\ & {\sum }_{i = 1}^{n} {b}_{i}^{t} \leq {N}_{t} ; ∀ t = 1 , 2 , … , T & ( max . price change per time ) \\ & {b}_{i}^{t} ∈ \{ 0 , 1 \} ; ∀ i = 1 , 2 , … , n and ∀ t = 1 , 2 , … , T & ( indicator for price change ) \\ & {p}_{i}^{t} ∈ {P}_{i} & ( price ladder ) \\ & ( {p}_{1}^{t} , {p}_{2}^{t} , … , {p}_{n}^{t} ) ∈ {L}_{p} ; ∀ t = 1 , 2 , … , T & ( feasible price constraints ) \\ & ( {s}_{1}^{t} , {s}_{2}^{t} , … , {s}_{n}^{t} ) ∈ {L}_{s} ; ∀ t = 1 , 2 , … , T & ( feasible sales constraints ) \\ & ( {p}_{1}^{t} {s}_{1}^{t} , {p}_{2}^{t} {s}_{2}^{t} , … , {p}_{n}^{t} {s}_{n}^{t} ) ∈ {L}_{r} ; ∀ t = 1 , 2 , … , T . & ( feasible revenue constraints )\end{matrix}$$

6. The computer readable medium of claim 1, wherein sᵢ⁰(t) comprises the demand model at time t, wherein sᵢ⁰(t)≡fᵢ^{t}(p₁⁰, . . . , pₙ⁰), and wherein the determined coefficients comprise δᵢⱼ^{m}(t)=fᵢ^{t}(p₁⁰, . . . , pⱼ₋₁⁰, pⱼ^{m}, pⱼ₊₁⁰, . . . , pₙ⁰)−sᵢ⁰(t).

7. The computer readable medium of claim 1, wherein the MILP problem comprises:
$${max}_{{x}_{i}^{m} ( t ) , {y}_{i}^{m} ( t ) , {b}_{i}^{t}} {\sum }_{t = 1}^{T} {\sum }_{i = 1}^{n} {\sum }_{m = 1}^{{M}_{i}} ( {p}_{i}^{m} - {c}_{i}^{t} ) {y}_{i}^{m} ( t )$$
$$s . t . \\ {\sum }_{m = 1}^{{M}_{i}} {x}_{i}^{m} ( t ) = 1 ; ∀ i = 1 , 2 , … , n and ∀ t = 1 , 2 , … , T$$
$${\sum }_{m = 1}^{{M}_{i}} {p}_{i}^{m} {x}_{i}^{m} ( t ) - {\sum }_{m = 1}^{{M}_{i}} {p}_{i}^{m} {x}_{i}^{m} ( t - 1 ) \leq {b}_{i}^{t} \cdot M ; ∀ i = 1 , 2 , … , n and ∀ t = 1 , 2 , … , T$$
$${\sum }_{m = 1}^{{M}_{i}} {p}_{i}^{m} {x}_{i}^{m} ( t - 1 ) - {\sum }_{m = 1}^{{M}_{i}} {p}_{i}^{m} {x}_{i}^{m} ( t ) \leq {b}_{i}^{t} \cdot M ; ∀ i = 1 , 2 , … , n and ∀ t = 1 , 2 , … , T$$
$${\sum }_{k = t}^{min ( t + {τ}_{i} - 1 , T )} {b}_{i}^{k} \leq 1 ; ∀ i = 1 , 2 , … , n and ∀ t = 1 , 2 , … , T$$
$${\sum }_{t = 1}^{T} {b}_{i}^{t} \leq {K}_{i} ; ∀ t = 1 , 2 , … , n$$
$${\sum }_{t = 1}^{n} {b}_{i}^{t} \leq {N}_{t} ; ∀ t = 1 , 2 , … , T$$
$${\sum }_{m = 1}^{{M}_{i}} {y}_{i}^{m} ( t ) = {s}_{i}^{0} ( t ) + {\sum }_{j = 1}^{n} {\sum }_{m = 1}^{{M}_{j}} {δ}_{ij}^{m} ( t ) {x}_{j}^{m} ( t ) ; ∀ i and ∀ t$$
$$0 \leq {y}_{i}^{m} ( t ) \leq {s}_{i}^{max} {x}_{i}^{m} ( t )$$
$${b}_{i}^{t} ∈ \{ 0 , 1 \} ; ∀ i = 1 , 2 , … , n and ∀ t = 1 , 2 , … , T$$
$${x}_{i}^{m} ∈ \{ 0 , 1 \} ; ∀ i = 1 , 2 , … , n ∀ m = 1 , 2 , … , {M}_{i} and ∀ t = 1 , 2 , … , T \\ ( {\sum }_{m = 1}^{{M}_{1}} {p}_{1}^{m} {x}_{1}^{m} ( t ) , … , {\sum }_{m = 1}^{{M}_{n}} {p}_{n}^{t} {x}_{n}^{m} ( t ) ) ∈ {L}_{p} ; ∀ t = 1 , 2 , … , T \\ ( {\sum }_{m = 1}^{{M}_{1}} {y}_{1}^{m} ( t ) , … , {\sum }_{m = 1}^{{M}_{n}} {y}_{n}^{m} ( t ) ) ∈ {L}_{s} ; ∀ t = 1 , 2 , … , T \\ ( {\sum }_{m = 1}^{{M}_{1}} {p}_{1}^{m} {x}_{1}^{m} ( t ) , … , {\sum }_{m = 1}^{{M}_{n}} {p}_{n}^{t} {x}_{n}^{m} ( t ) ) ∈ {L}_{r} ; ∀ t = 1 , 2 , … , T .$$

8. The computer readable medium of claim 1, further comprising converting the MILP solution, the converting comprising:
$$for all i = 1 , … , n and t = 1 , … , T : {p}_{i} ( t ) = {\sum }_{m = 1}^{{M}_{i}} {p}_{i}^{m} {x}_{i}^{m} ( t ) .$$

9. A computer implemented method for determining time-dependent product pricing for a product category, the method comprising:
receiving a non-linear time-dependent problem for the product category, wherein the non-linear problem comprises a demand model;
for a plurality of pair of products in the product category, determining coefficients for a change in demand of a first product at each of a plurality of time periods when a price of a second product is changed;
generating an approximate Mixed Integer Linear Programming (MILP) problem comprising a change of demand based on a sum of the determined coefficients; and
solving the MILP problem to obtain a MILP solution, wherein the MILP solution provides the product pricing.

10. The method of claim 9, wherein the solving the MILP problem comprises setting a solved price of each product to a non-zero binary variable.

11. The method of claim 9, wherein the non-linear problem comprises assigning prices on products from a price ladder.

12. The method of claim 9, wherein the product category comprises pricing that is at least in part dependent on seasonality.

13. The method of claim 9, wherein the non-linear time-dependent problem comprises:
$$\begin{matrix}{max}_{{p}_{i}^{t} , {b}_{i}^{t}} Obj ( {p}_{i}^{t} ) & & ( maximize some objective func . ) \\ s . t . & {s}_{i}^{t} = {f}_{i}^{t} ( {p}_{1}^{t} , {p}_{2}^{t} , … , {p}_{n}^{t} ) & ( sales as function of prices ) \\ & {p}_{i}^{t} - {p}_{i}^{t - 1} \leq {b}_{i}^{t} \cdot Δ ; ∀ i = 1 , 2 , … , n and ∀ t = 1 , 2 , … , T & ( price diff . forcing constraint ) \\ & {p}_{i}^{t - 1} - {p}_{i}^{t} \leq {b}_{i}^{t} \cdot Δ ; ∀ i = 1 , 2 , … , n and ∀ t = 1 , 2 , … , T & ( price diff . forcing constraint ) \\ & {\sum }_{k = t}^{min ( t + {τ}_{i} - 1 , T )} {b}_{i}^{k} \leq 1 ; ∀ i = 1 , 2 , … , n and ∀ t = 1 , 2 , … , T & ( ‘ no touch ’ period ) \\ & {\sum }_{t = 1}^{T} {b}_{i}^{t} \leq {K}_{i} ; ∀ t = 1 , 2 , … , n & ( max . price change per item ) \\ & {\sum }_{i = 1}^{n} {b}_{i}^{t} \leq {N}_{t} ; ∀ t = 1 , 2 , … , T & ( max . price change per time ) \\ & {b}_{i}^{t} ∈ \{ 0 , 1 \} ; ∀ i = 1 , 2 , … , n and ∀ t = 1 , 2 , … , T & ( indicator for price change ) \\ & {p}_{i}^{t} ∈ {P}_{i} & ( price ladder ) \\ & ( {p}_{1}^{t} , {p}_{2}^{t} , … , {p}_{n}^{t} ) ∈ {L}_{p} ; ∀ t = 1 , 2 , … , T & ( feasible price constraints ) \\ & ( {s}_{1}^{t} , {s}_{2}^{t} , … , {s}_{n}^{t} ) ∈ {L}_{s} ; ∀ t = 1 , 2 , … , T & ( feasible sales constraints ) \\ & ( {p}_{1}^{t} {s}_{1}^{t} , {p}_{2}^{t} {s}_{2}^{t} , … , {p}_{n}^{t} {s}_{n}^{t} ) ∈ {L}_{r} ; ∀ t = 1 , 2 , … , T . & ( feasible revenue constraints )\end{matrix}$$

14. The method of claim 9, wherein sᵢ⁰(t) comprises the demand model at time t, wherein sᵢ⁰(t)≡fᵢ^{t}(p₁⁰, . . . , pₙ⁰), and wherein the determined coefficients comprise δᵢⱼ^{m}(t)=fᵢ^{t}(p₁⁰, . . . , pⱼ₋₁⁰, pⱼ^{m}, pⱼ₊₁⁰, . . . , pₙ⁰)−sᵢ⁰(t).

15. The method of claim 9, wherein the MILP problem comprises:
$${max}_{{x}_{i}^{m} ( t ) , {y}_{i}^{m} ( t ) , {b}_{i}^{t}} {\sum }_{t = 1}^{T} {\sum }_{i = 1}^{n} {\sum }_{m = 1}^{{M}_{i}} ( {p}_{i}^{m} - {c}_{i}^{t} ) {y}_{i}^{m} ( t )$$
$$s . t . \\ {\sum }_{m = 1}^{{M}_{i}} {x}_{i}^{m} ( t ) = 1 ; ∀ i = 1 , 2 , … , n and ∀ t = 1 , 2 , … , T$$
$${\sum }_{m = 1}^{{M}_{i}} {p}_{i}^{m} {x}_{i}^{m} ( t ) - {\sum }_{m = 1}^{{M}_{i}} {p}_{i}^{m} {x}_{i}^{m} ( t - 1 ) \leq {b}_{i}^{t} \cdot M ; ∀ i = 1 , 2 , … , n and ∀ t = 1 , 2 , … , T$$
$${\sum }_{m = 1}^{{M}_{i}} {p}_{i}^{m} {x}_{i}^{m} ( t - 1 ) - {\sum }_{m = 1}^{{M}_{i}} {p}_{i}^{m} {x}_{i}^{m} ( t ) \leq {b}_{i}^{t} \cdot M ; ∀ i = 1 , 2 , … , n and ∀ t = 1 , 2 , … , T$$
$${\sum }_{k = t}^{min ( t + {τ}_{i} - 1 , T )} {b}_{i}^{k} \leq 1 ; ∀ i = 1 , 2 , … , n and ∀ t = 1 , 2 , … , T$$
$${\sum }_{t = 1}^{T} {b}_{i}^{t} \leq {K}_{i} ; ∀ t = 1 , 2 , … , n$$
$${\sum }_{t = 1}^{n} {b}_{i}^{t} \leq {N}_{t} ; ∀ t = 1 , 2 , … , T$$
$${\sum }_{m = 1}^{{M}_{i}} {y}_{i}^{m} ( t ) = {s}_{i}^{0} ( t ) + {\sum }_{j = 1}^{n} {\sum }_{m = 1}^{{M}_{j}} {δ}_{ij}^{m} ( t ) {x}_{j}^{m} ( t ) ; ∀ i and ∀ t$$
$$0 \leq {y}_{i}^{m} ( t ) \leq {s}_{i}^{max} {x}_{i}^{m} ( t )$$
$${b}_{i}^{t} ∈ \{ 0 , 1 \} ; ∀ i = 1 , 2 , … , n and ∀ t = 1 , 2 , … , T$$
$${x}_{i}^{m} ∈ \{ 0 , 1 \} ; ∀ i = 1 , 2 , … , n ∀ m = 1 , 2 , … , {M}_{i} and ∀ t = 1 , 2 , … , T \\ ( {\sum }_{m = 1}^{{M}_{1}} {p}_{1}^{m} {x}_{1}^{m} ( t ) , … , {\sum }_{m = 1}^{{M}_{n}} {p}_{n}^{t} {x}_{n}^{m} ( t ) ) ∈ {L}_{p} ; ∀ t = 1 , 2 , … , T \\ ( {\sum }_{m = 1}^{{M}_{1}} {y}_{1}^{m} ( t ) , … , {\sum }_{m = 1}^{{M}_{n}} {y}_{n}^{m} ( t ) ) ∈ {L}_{s} ; ∀ t = 1 , 2 , … , T \\ ( {\sum }_{m = 1}^{{M}_{1}} {p}_{1}^{m} {x}_{1}^{m} ( t ) , … , {\sum }_{m = 1}^{{M}_{n}} {p}_{n}^{t} {x}_{n}^{m} ( t ) ) ∈ {L}_{r} ; ∀ t = 1 , 2 , … , T .$$

16. The method of claim 9, further comprising converting the MILP solution, the converting comprising:
$$for all i = 1 , … , n and t = 1 , … , T : {p}_{i} ( t ) = {\sum }_{m = 1}^{{M}_{i}} {p}_{i}^{m} {x}_{i}^{m} ( t ) .$$

17. A product pricing optimization system that determines time-dependent product pricing for a product category wherein the non-linear problem comprises a demand model, the system comprising:
a coefficient generator that, for a plurality of pair of products in the product category, generates coefficients for a change in demand of a first product at each of a plurality of time periods when a price of a second product is changed;
a Mixed Integer Linear Programming (MILP) generator that generates an approximate MILP problem comprising a change of demand based on a sum of the determined coefficients; and
a MILP solver that solves the MILP problem to obtain a MILP solution, wherein the MILP solution provides the product pricing.

18. The system of claim 17, wherein the solving the MILP problem comprises setting a solved price of each product to a non-zero binary variable.

19. The system of claim 17, wherein the non-linear problem comprises assigning prices on products from a price ladder.

20. The system of claim 17, wherein the product category comprises pricing depending on seasonality.
